(19) United States
(12) Patent Application Publication
(10) Pub. No.: US 2009/0255387 A1
(43) Pub. Date: Oct. 15, 2009

(54) VISION SYSTEM AND METHOD THEREOF

(75) Inventor: Gary Pelletier, Oswego, IL (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 12/179,435

(22) Filed: Jul. 24, 2008

Related U.S. Application Data
(60) Provisional application No. 60/951,891, filed on Jul. 25, 2007.

(51) Int. Cl. B23D 36/00

(52) U.S. Cl. 83/13; 83/358

(57) ABSTRACT

A system or apparatus of monitoring and adjusting the location of a perforation cut during production of a plastic sheet.

This application claims priority under 35 U.S.C. § 119(e) to U.S. Provisional Application Ser. No. 60/951,891, entitled “VISION SYSTEM AND METHOD THEREOF,” filed Jul. 25, 2007, which is expressly incorporated by reference herein.

### BACKGROUND

The present disclosure relates to a system and method for detecting and correcting defects in an automated production system. More specifically, embodiments of the present invention relate to a system and method for automatically detecting and correcting manufacturing defects in plastic bags.

Plastic bags are typically made from a web or roll of folded plastic film. Seams are applied to the film to form the bag which is separable by a perforation. Typically, the two seams are space a distance (illustratively about an inch) apart. The perforation is then cut between the seams. During manufacturing of the bags the location of the perforation cut can drift to the right or left (relative to the direction of the moving plastic) toward or away from the seams. This causes the perforation to be too close or too far from the seams.

It would be beneficial to provide a system for correcting this drift during the manufacturing process so the perforation is located in the proper position relative to the seam.

### SUMMARY

The present disclosure describes a system for monitoring and correcting the position of a perforation during manufacture of plastic bags and the like. The location of the perforation relative to the seam is constantly monitored with certain deviations causing an alert. When needed, the system includes a correction mechanism that moves the perforation blade to the proper location.

An embodiment of the present disclosure provides a system for detecting and correcting defects. The illustrative system comprises a data file, wherein manufacturing specifications are stored, a production line, at least one device configured to provide treatment to goods on the production line, at least one sensor configured to capture data from goods passing on the production line, a computer system configured to receive, store, process, and send data, a controller operatively connected to the computer system and configured to send feedback, and an actuator operatively connected to the controller and configured to receive feedback from the controller.

Illustrative embodiments of the present disclosure relate to a method for detecting and correcting defects and may comprise providing a data file, providing a production line, transporting goods upon the production line, providing at least one sensor, capturing data from the goods with the sensor, communicating the data from the sensor to a computer system, detecting a defect whereby a reference data is compared to the data captured by the sensor, transmitting an output signal to a controller; processing output signals via the controller, generating corrective production specifications, communicating feedback production specifications from the controller to a actuator, and adjusting production specifications via the actuator, wherein the adjustments correct the detected defect.

Other embodiments of the present disclosure provide a system for detecting and correcting plastic bag manufacturing defects which may comprise a data file, a processing line, a heat welding device operatively connected to the processing line, a perforating device operatively connected to the processing line, at least one sensor configured to gather input from goods passing on the production line, a computer system in communication with the sensor, configured to store a reference and compare an image with said reference, a programmable logic controller operatively connected to the computer, wherein feedback is generated, and a perforation servomechanism operatively connected to the programmable logic controller.

Another embodiment of the present disclosure comprises a system or apparatus of monitoring and adjusting the location of a perforation during production of a plastic sheet. The system comprises a monitor that captures an image of the perforation cut into the plastic sheet; a computer that processes the image and determines whether the perforation is located in a desired position; and a controller that moves the a perforation blade if the computer determined that the perforation was not in the desired position.

The above and other embodiments may further comprise: the plastic sheet being a web of a plurality of folded plastic bags; the plastic sheet having a seal located adjacent and spaced apart from the perforation, the monitor capturing an image of the perforation and the seal, the computer determining whether the perforation is located in a desired position relative to the seal, and the controller moving the position of the perforation blade relative to the seal if the computer determined that the perforation was not in the desired position; the monitor being a camera; the camera capturing an image that is transmitted to the computer which includes a reference image that the image is compared to determine whether the perforation is located in the desired position; the controller including a programmable logic controller that receives corrective data from the computer moves the perforation blade if the perforation was not in the desired position; the controller being in communication with a perforation servomechanism that receives commands from the controller to move the perforation blade; movement of the perforation blade ensuring that subsequent perforations in the plastic sheet are in the desired position; the computer issuing a deadband to the controller if the perforation is located in the desired position.

Another illustrative embodiment is a method of monitoring and adjusting the location of a perforation during production of a plastic sheet. This method comprises the steps of: moving a length of the plastic sheet along a conveyor; monitoring the plastic sheet by capturing an image of the perforation cut into the plastic sheet; processing the image to determine whether the perforation is located in a desired position; and moving the a perforation blade if determined that the perforation was not in the desired position.

The above and other embodiments may further comprise the steps of: moving the plastic sheet which is a web of a plurality of folded plastic bags; providing a seal adjacent to and space apart from the perforation; capturing an image of the perforation and the seal, determining whether the perforation is located in a desired position relative to the seal, and moving the perforation blade relative to the seal if determined that the perforation was not in the desired position; providing a camera to monitor the plastic sheet; capturing an image that is transmitted to a computer which includes a reference image that is compared to the image to determine whether the perforation is located in the desired position; moving the perforation blade with the assistance of a programmable logic controller that receives corrective data from the computer when the perforation is not located in the desired position; providing a perforation servomechanism that receives commands from a controller for moving the perforation blade; moving the perforation blade to ensure that subsequent perforations in the plastic sheet are in the desired position; and sending a deadband if the perforation is located in the desired position.

Another embodiment includes a method of detecting two variables that are introduced at different points in the process relating to the art of bag making machinery, particularly to rotary bag making machines. The first variable is a heat welding device used to double seal two layers of plastic film together at about 1-inch paralleled seals illustratively perpendicular to the direction of a web path. A second variable can be introduced as a perforating device to perforate the plastic between the adjacent seals. Defects are related to process variables which affect the quality of the product. Quality Control Imaging and pattern recognition algorithms are applied. Once inspection of the variables has been performed, an output signal is used to effect a control action at the rotary bag machine. This method illustratively includes a) an image snapshot capturing the two variables introduced into the process as in claim 1; b) an image-capturing device monitors, records and reacts to a preset template of conditions given via computer program, wherein if the variables that pass before the capturing device deviate from the template and the preset measurements are recognized, the system or user is notified of the discrepancy; c) a perforation detector signal used to fire and rest the capturing device, wherein the signal is in close proximity of the capturing device which helps to stabilize the image at high production speeds; d) when a deviation is detected on a captured image, immediate feed back is sent for process corrections creating a closed loop control; e) depending on direction of deviation (upstream, downstream), one of two signals are sent to correct the registered error; f) a deadband control is utilized to eliminate oscillation in the process when no action is required, wherein a no alarm condition exists when the measured process enters the deadband range.

Additional features of the present disclosure will become apparent to those skilled in the art upon consideration of the following detailed description of preferred embodiments exemplifying the best mode of carrying out the disclosure as presently perceived.

### BRIEF DESCRIPTION OF THE DRAWINGS

The detailed description particularly refers to the accompanying figures in which:

FIG. 1 is a block diagram of a computer system according to an embodiment of the this disclosure;

FIG. 2 is another illustrative system according to an embodiment of the this disclosure;

FIG. 3 is a flow chart of a monitoring system according to an embodiment of the this disclosure;

FIGS. 4a and 4b are images of plastic sheeting with target boxes which generally define an area or characteristic of interest;

FIG. 5 is a flow chart of a detection system according to an embodiment of the this disclosure;

FIG. 6 is a flow chart of a corrective system in accordance with one embodiment of the present invention; and

FIG. 7 is a flow chart of a method of detecting and correcting defects according to an embodiment of the disclosure.

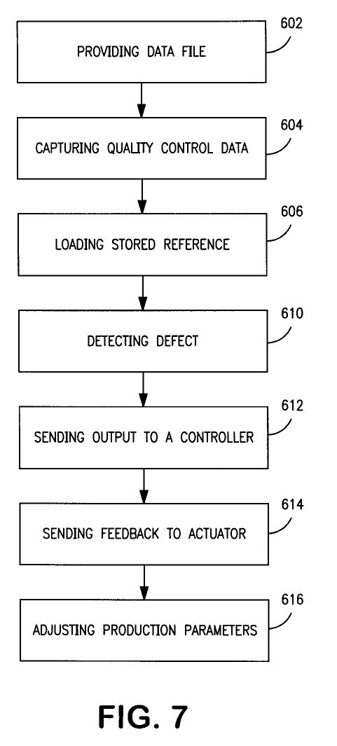

### DETAILED DESCRIPTION

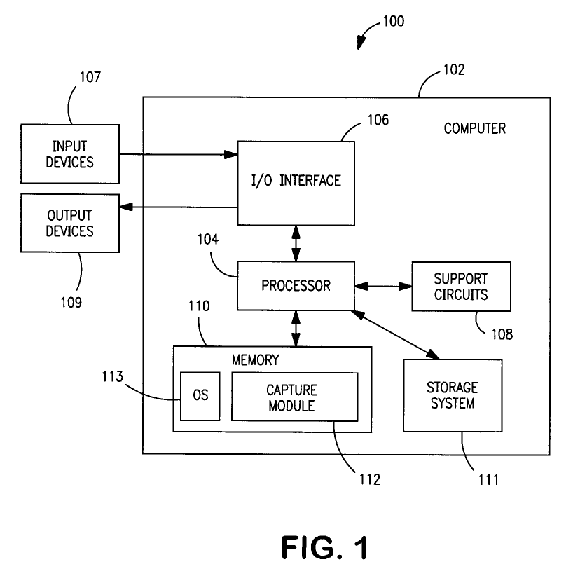

A block diagram of a computer system 100 according to an embodiment of the present disclosure is shown in FIG. 1. Computer system 100 generally comprises a computer 102. Computer 102 illustratively comprises a processor 104, a memory 110, various support circuits 108, an input/output (“I/O”) interface 106, and a storage system 111. Processor 104 may include one or more microprocessors. Support circuits 108 for processor 104 may include conventional cache, power supplies, clock circuits, data registers, I/O interfaces, and the like. I/O interface 106 may be directly coupled to memory 110 or coupled through processor 104. Additionally, I/O interface 106 may be configured for communication with input devices 107 and/or output devices 109, such as network devices, various storage devices, mouse, keyboard, displays, and the like. Storage system 111 may comprise any type of block-based storage device or devices, such as a disk drive system.

Memory 110 stores processor-executable instructions and data that may be executed by and used by the processor 104. These processor-executable instructions may comprise hardware, firmware, software, and the like, or combinations thereof. Modules having processor-executable instructions that are stored in the memory 110 may include a capture module 112. Computer 102 may be programmed within an operating system 113, which may include OS/2, Java Virtual Machine, Linux, Solaris, Unix, HPUX, AIX, Windows, MacOS, among other platforms. At least a portion of operating system 113 may be stored in the memory 110. Memory 110 may include one or more of the following: random access memory, read only memory, magnetoresistive read/write memory, optical read/write memory, cache memory, magnetic read/write memory, and the like.

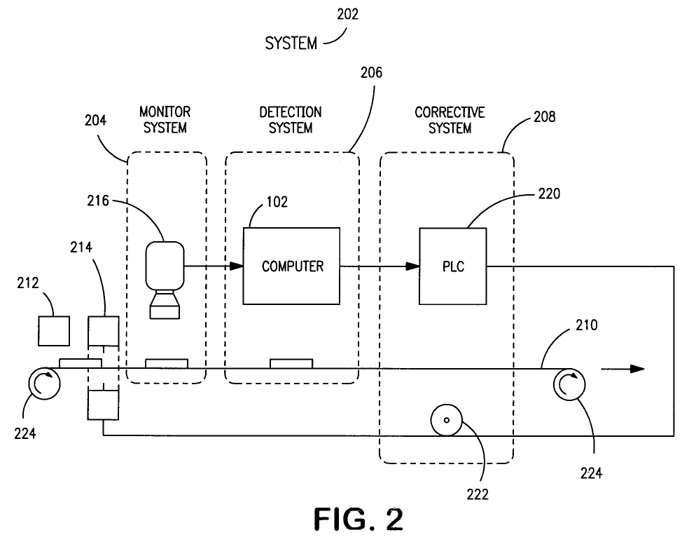

A diagram of system 202 is shown in FIG. 2. System 202 generally comprises a monitoring system 204, a detection system 206, and a corrective system 208. System 202 may further include a conveyor belt system 210, a heat welding device 212, a perforating device 214, a sensor 216, the computer system 100, a programmable logic controller 220, and a corrective mechanism 222.

System 202 may include an underlying conveyor system 210 being advanced in a production direction, along an extending path, by draw rollers 224. Omitted for clarity is a complete production line whereby raw materials require sequential steps to render a finished product. This production line is known to those skilled in the art.

System 202 may also include treatment tools that modify goods. In one embodiment, the system may include a heat welding device 212. In another embodiment, the system may include a perforating device 214. In yet another embodiment, the system may include both a heat welding device and a perforating device. The heat welding device 212 is used to double seal two layers of plastic film together at illustratively, one inch paralleled seals perpendicular to the direction of the underlying belt movement. It is appreciated that other sealing configurations may be used. Similarly, perforating device 214 may include a perforation blade or equivalent that is used to perforate the plastic between the adjacent seals. It is understood that a variety of different tools may treat the material as it passes through the production line. For example, tools may provide treatments such as resizing, shaping, cutting and pressing.

Monitoring system 204 includes at least one sensor 216. This sensor 216 may be positioned on the conveyor belt system illustratively after the goods receive treatment and before the end of the conveyor belt system. Sensor 216 is configured to capture quality control data from goods advancing on the conveyor belt system. Based on the speed at which goods advance, the sensor may be able to capture data at a high rate of speed. In one illustrative embodiment, sensor 216 may comprise a digital or analog camera that captures images on white or black film. Camera specifications may include, but not limited to, ⅓″ VGA CCD Imager, active pixels 656×494, 5.79 (H)×4.89 (V) active area (mm), 100 frames per second (“fps”) @ 40 MHz, and a minimum illumination of 1.0 lux at 100 fps. Optionally, the sensor may include electric eye sensors, infrared sensors, motion sensors, temperature sensors, vision cameras, and ultraviolet and other visible spectrum light sensors. Alternative embodiments of this disclosure may comprise an analog-to-digital component designed for digitizing analog signals.

The detection system 206 may include computer system 100. (See also FIG. 1.) Illustratively, computer system 100 is located in close proximity to the sensor to reduce the transfer time. This close proximity configuration may be implemented when data is being captured at high production speeds. Computer system 100 is in communication with the senor through any viable communication medium, such as a serial cable, wireless, Ethernet, Universal Serial Bus (“USB”), or the like, for example.

Corrective system 208 may comprise a programmable logic controller (“PLC”) 220 and a corrective mechanism 222. PLC 220 is a digital computer used for automation of industrial processes, such as control of machinery on factory assembly lines. Unlike general-purpose computers, PLC 220 is designed for multiple inputs and output arrangements, extended temperature ranges, immunity to electrical noise, and resistance to vibration and impact. The input/output arrangement may be built into a simple PLC, or the PLC may have external I/O modules attached to a computer network that plugs into the PLC. Programs to control machine operation are typically stored in battery-backed or non-volatile memory.

Optionally, PLC 220 and computer system 100 may be combined into one unit. In other words, the functionality of both the computer system and the PLC may be conducted by one computer system. Organizationally, as known to those skilled in the art, the computer system and the programmable logic controller may further be installed in the same location through a rack installation, or similar configuration.

Corrective mechanism 222 may comprise a mechanism to correct defects generated by the production line. PLC 220 is connected to an electro servo drive which moves or controls the perforation blade. The actuator is usually a physical mechanism, but also may refer to an artificial intelligent agent. In one embodiment, the corrective mechanism may comprise a perforation servomechanism (“servo”). The servo is optimally connected to the production line and, more specifically, to tools that provide treatment to the raw materials or products. For example, the servo can be connected to perforating device 214 such that adjustments may be made when plastic bag seals do not meet specification.

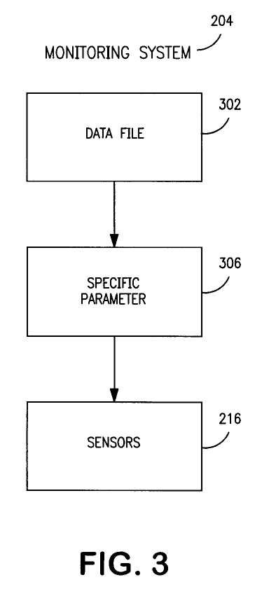

A block diagram of a monitor system 204 is shown in FIG. 3. System 204 comprises data files 302 and at least one sensor 216. Data files 302 hold data related to plastic bag manufacturing such as bag size, camera settings, and perforation settings. Specific parameters 306 are utilized to determine the monitoring requirements on a per-job basis. Moreover, data files 302 enable an operator to load a manufacturing run, along with all the customized manufacturing parameters by selecting a specific data file associated with the run. In one illustrative embodiment, sensor 216 may be configured to monitor plastic bag perforations. In another illustrative embodiment, sensor 216 may be configured to monitor plastic bag seals.

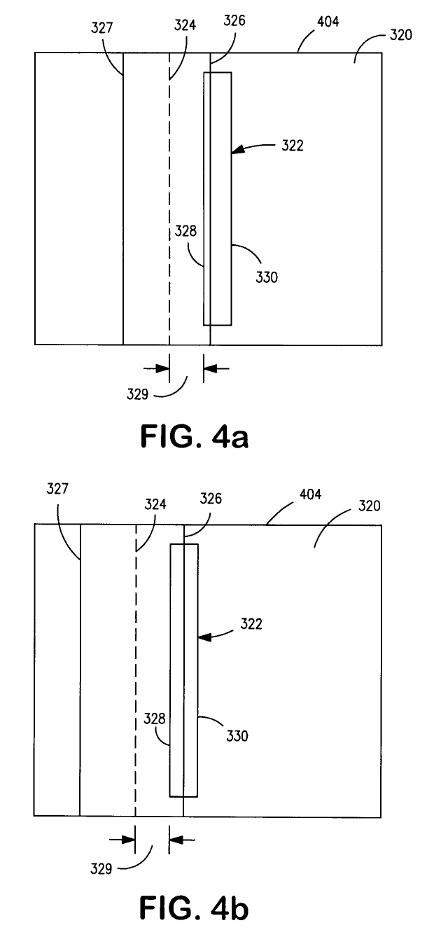

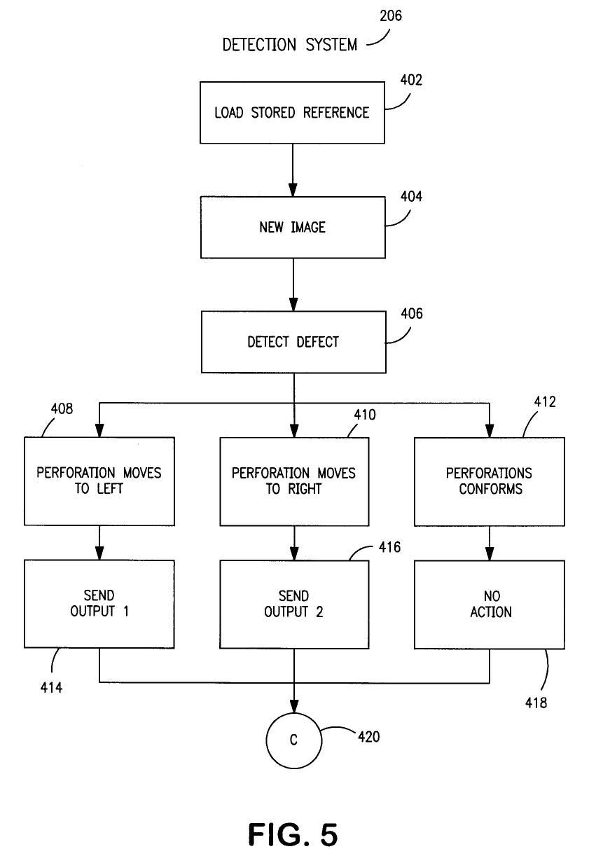

In operation, sensors 216 may be configured to focus on a particular characteristic of the goods. Specifically, a data file or operator may configure a target box whereby sensor 216 focuses on the particular area or characteristic of the plastic sheets. As shown in FIGS. 4a and b, an image 404 (see also FIG. 5) is taken of plastic sheeting 320. A target box 322 which generally defines an area or characteristic of interest is superimposed on image 404. In this case, target box 322 maintains a fixed distance 329 from perforation 324. A seam 326 is located inside target box 322. (Seam 327 is located on the opposite side of perforation 324.) In an illustrative embodiment, if seam 326 is too close to either the left side 328 or right side 330 of target box 322, then a corrective function is engaged to adjust the perforation blade.

As shown in FIG. 4b, once the perforation blade is moved, seam 326 moves back toward the center of target box 322. As more bags pass under sensor 216 and are photographed, seam 326 should stay close to the center of target box 322. If, however, perforation 324 drifts (target box 322 stays the same distance from perforation 324), seam 326 will drift as well. Once this drift is detected, corrective measures will once again be initiated.

To accomplish all of this, approximately 1 to 100,000 data points in the image are read. Some embodiments may utilize as many data points as capable and sustainable. A flow chart of a detection system 206 is shown in FIG. 4. After sensor 216 captures quality control data, the data may transmit to computer system 100. Computer system 100, as described above, may process a computer readable medium having instructions to load a stored reference 402, to compare with the quality control data. In control systems and used herein, the desired output of a system is called the reference. The computer readable medium may further include quality control imaging and pattern recognition algorithms. In one embodiment, the computer system may store the reference data, which is also called a template or target parameter. The computer readable medium may load a reference 402 and compare it against the recently captured image 404 from sensor 216.

In operation, detection system 206 may provide a number of different detection methods. In one embodiment, a defect 406 may be detected by pixel counting whereby the number of light or dark pixels of the reference is compared with the captured image pixels. Additional embodiments may further comprise blob discovery whereby an image is inspected for discrete blobs of connected pixels as image landmarks. In yet another embodiment, defect detection 406 may comprise template matching whereby images are compared by finding, matching, and/or counting specific patterns. In still another embodiment, system 400 may comprise any combination of the above defect detection methods.

After determining defect 406 exists, computer system 100 may generate an output to PLC 220. Illustratively, the location of the perforation with respect to defects corresponds to a specific output. For instance (and as discussed with respect to FIGS. 4a and b), a perforation to the left 408 may correspond to output 1 at 414, while a perforation to the right 410 may correspond to output 2 at 416. In an illustrative embodiment, an alarm may sound when a product defect is detected at 406. These alarms may include visual and audio alarms to an operator, or any form of an electronic alarm. Examples of electronic alarms may include email, pager, instant message, pop-up, report generation, or the like. In an additional embodiment, the notification can be a series of lights such as green, yellow and red. If the light is green, the perforation is within an optimum tolerance and no adjustment is needed. If red, correction may be needed such as shifting the perforation blade illustratively to the left to get the perforation back within the optimum tolerance. If the light is yellow, correction may also be needed but now the perforation blade may need to be shifted the other way to get the perforation back within the optimum tolerance.

A flow chart of corrective system 208 is shown in FIG. 5. Computer system 100 sends a defect output 502 to PLC 220. Illustratively, PLC 220 includes communication ports such as 9-Pin RS232, RS485, Ethernet, and the like. Communication protocols used may include Modbus, DF1, and other communication network protocols. By employing these communication capabilities, the PLC is able to receive notification from the computer system.

In control theory, a closed-loop, also called a feedback control system, uses feedback to control states or outputs of a dynamical system. In operation, process inputs have an effect on the process outputs, which is measured with sensors and processed by the controller, wherein the result is used as input to the process, closing the loop. Embodiments of the present invention may provide a controller comprising a closed-loop architecture. Optionally, the system may comprise a closed-loop and open loop control simultaneously, wherein the open-loop control is termed feedforward and serves to further improve reference tracking performance.

After PLC 220 receives defect 503 output from computer system 100, it processes the particular output at 504. Processing may include determining what corrective actions need to be taken. Corrective parameters are then sent at 506. Illustratively, programming gives an output signal to control overshooting when correcting the defect. The output and/or notification may be in any form capable of conveying corrective parameters to an actuator.

PLC 220 further comprises a deadband, which is an area of a signal range or band where no action occurs (the system is dead). When no defects are detected, computer system 100 does not send an output so PLC 220 takes no corrective actions. Most commonly, deadband is used in voltage regulators, thermostats, and alarms. The purpose for deadband is to prevent oscillation or repeated activation-deactivation cycles (called “hunting” in proportional control systems).

The actuator receives corrective parameters 508 from PLC 220. In an illustrative embodiment, the perforation servo serves as the actuator. Based on the parameters received, the perforation servo may adjust production to correct the position of the perforation blade at 510. Illustratively, receiving a corrective parameter may cause the perforation servo to initiate a correction sequence that adjusts the perforation blade so no more seal defects occur. It is understood to those in the art, however, that any device that may provide control of a desired operation through the use of feedback may serve as an actuator.

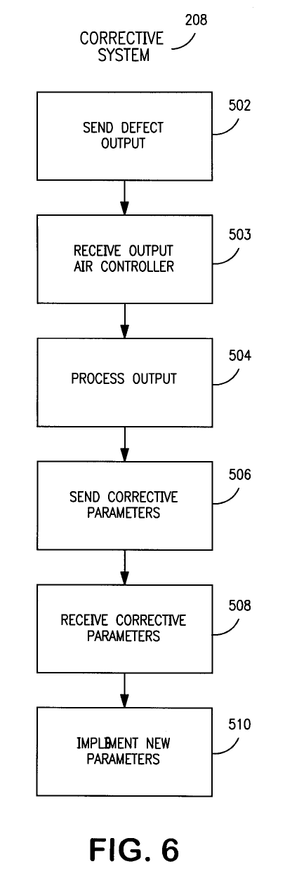

A flow chart of a method of detecting and corrective defects is shown in FIG. 6. The method 2 is described with respect to the system 202 disclosed in FIG. 2. Illustratively, production output includes providing a data file at 602 that may comprise a plastic bag that has been heat sealed and perforated. Optionally, the production output may comprise any goods, product, or material subjected to a quality assurance process.

At step 604, the method captures data of the production output. As discussed in more detail above, there are a variety of methods to capture data. The method used to capture data will depend on a number of factors, including cost, the subject matter, and accuracy. In one embodiment, an image may be captured with a photographic device using white film. Illustratively, an image may be captured with a photographic device using black film, or even digitally using no film. The capturing device focuses on a particular area or feature, and adjusts itself ensuring it captures that particular area or feature.

At step 606, the computer system loads a stored reference from its memory. This reference may comprise the target parameter for determining if a defect exists. Illustratively, the stored reference may comprise an image of a plastic bag with a seal and perforation within a target box. Optionally, the step of loading a stored reference 608 may utilize other computer systems and/or network topologies.

At step 610, the method detects if a defect exists. To accomplish this step, the reference is compared with the captured data. Illustratively, the detection may occur using an application programmed to focus on the alignment of a seal. In addition, the application may focus on the perforation to determine if there is a defect. This detection comprises a pixel examination of images and attempting to develop conclusions with assistance of knowledge bases and features such as pattern recognition engines, and the like. Optionally, systems may be programmed to perform tasks such as counting objects on a conveyor, reading serial numbers, and searching for surface defects. When no defect is determined, the method may be completed, such that no corrective action takes place (deadband). Alternatively, if a defect is detected, the method performs other steps.

Step 612 comprises sending an output to a controller. The format for sending an output may comprise analog, digital, audio, visual, or the like. Illustratively, a computer system may send an output to PLC 220. Optionally, if the computer system and the PLC functionality are combined within one unit, sending an output to a controller would comprise internal computer system communication.

At 614, an actuator, or the like, receives feedback from the PLC and may provide adjustments at 616 to mechanisms within the system. A perforation servomechanism where, depending on the feedback, adjustments to the perforating device are made to correct misaligned perforations. Another illustrative embodiment includes a heat welding device being adjusted by the servomechanism.

1. A system of monitoring and adjusting the location of a perforation cut during production of a plastic sheet, the system comprising
a monitor that captures an image of the perforation cut into the plastic sheet,
a computer that processes the image and determines whether the perforation is located in a desired position, and
a controller that moves a perforation blade if the computer determined that the perforation was not in the desired position.

2. The system of claim 1, wherein the plastic sheet is a web of a plurality of folded plastic bags.

3. The system of claim 1, wherein the plastic sheet further comprises a seal that located adjacent and spaced apart from the perforation.

4. The system of claim 3, wherein the monitor captures an image of the perforation and the seal, wherein the computer determines whether the perforation is located in a desired position relative to the seal, and wherein the controller moves the position of the perforation blade relative to the seal if the computer determined that the perforation was not in the desired position.

5. The system of claim 3, wherein the monitor is a camera.

6. The system of claim 5, wherein the camera captures an image that is transmitted to the computer which includes a reference image that the image is compared to determine whether the perforation is located in the desired position.

7. The system of claim 6, wherein the controller includes a programmable logic controller that receives corrective data from the computer moves the perforation blade if the perforation was not in the desired position.

8. The system of claim 1, wherein the controller is in communication with a perforation servomechanism that receives commands from the controller to move the perforation blade.

9. The system of claim 7, where movement of the perforation blade ensures that subsequent perforations in the plastic sheet are in the desired position.

10. The system of claim 10, wherein the computer issues a deadband to the controller if the perforation is located in the desired position.

11. A method of monitoring and adjusting the location of a perforation during production of a plastic sheet, the method comprising the steps of
moving a length of the plastic sheet along a conveyor,
monitoring the plastic sheet by capturing an image of the perforation cut into the plastic sheet,
processing the image to determine whether the perforation is located in a desired position, and
moving a perforation blade if determined that the perforation was not in the desired position.

12. The method of claim 11, further comprising the step of moving the plastic sheet which is a web of a plurality of folded plastic bags.

13. The method of claim 11, further comprising the step of providing a seal adjacent to and space apart from the perforation.

14. The method of claim 13, further comprising the steps of capturing an image of the perforation and the seal; determining whether the perforation is located in a desired position relative to the seal; and moving the perforation blade relative to the seal if determined that the perforation was not in the desired position.

15. The method of claim 11, further comprising the step of providing a camera to monitor the plastic sheet.

16. The method of claim 15, further comprising the steps capturing an image that is transmitted to a computer which includes a reference image that is compared to the image to determine whether the perforation is located in the desired position.

17. The method of claim 14, further comprising the step of moving the perforation blade with the assistance of a programmable logic controller that receives corrective data from the computer when the perforation is not located in the desired position.

18. The method of claim 11, further comprising the step of providing a perforation servomechanism that receives commands from a controller for moving the perforation blade.

19. The method of claim 11, further comprising the step of moving the perforation blade to ensure that subsequent perforations in the plastic sheet are in the desired position.

20. The method of claim 11, further comprising the step of sending a deadband if the perforation is located in the desired position.
